(19) United States
(12) Patent Application Publication
(10) Pub. No.: US 2021/0310475 A1
(43) Pub. Date: Oct. 7, 2021

(54) DRIVE SYSTEM FOR A POSITIVE DISPLACEMENT PUMP

(71) Applicant: Graco Minnesota Inc., Minneapolis, MN (US)

(72) Inventors: Bradley H. Hines, Andover, MN (US); Brian W. Koehn, Minneapolis, MN (US); Jeffrey A. Earles, Lakeville, MN (US); Paul W. Scheierl, Circle Pines, MN (US); Adam K. Collins, Brooklyn Park, MN (US)

(21) Appl. No.: 17/348,309

(22) Filed: Jun. 15, 2021

Related U.S. Application Data
(63) Continuation of application No. 16/204,863, filed on Nov. 29, 2018.
Application No. 16/204,863 is a continuation of application No. 14/579,551, filed on Dec. 22, 2014, now Pat. No. 10,161,393.
(60) Provisional application No. 62/022,263, filed on Jul. 9, 2014.
(60) Provisional application No. 61/937,266, filed on Feb. 7, 2014.

(51) Int. Cl. F04B 43/02; F04B 43/04; F04B 43/06; F04B 17/04; F04B 45/053; F04B 9/02; F04B 9/117; F04B 9/137; F04B 17/03; F04B 35/04; F04B 53/10; F04B 35/01; F04B 45/047; F04B 1/14; F04B 27/10; F04B 53/14

(52) U.S. Cl. CPC F04B 43/025; F04B 53/14; F04B 43/06; F04B 17/044; F04B 45/053; F04B 9/02; F04B 9/1176; F04B 9/1376; F04B 17/03; F04B 35/04; F04B 53/10; F04B 35/01; F04B 53/1002; F04B 45/047; F04B 1/14; F04B 27/10; F04B 43/04

(57) ABSTRACT

A drive system for a pump includes a housing, first and second fluid displacement members, and a reciprocating member configured to mechanically displace the first and second fluid displacement members through respective suction strokes. The housing and fluid displacement members define an internal pressure chamber configured to be filled with a working fluid having a charge pressure. The internal pressure chamber is configured such that the working fluid simultaneously exerts the charge pressure on the first and second fluid displacement members.

### CROSS-REFERENCE TO RELATED APPLICATION(S)

This application is a continuation of U.S. patent application Ser. No. 16/204,863 filed Nov. 29, 2018 and entitled “DRIVE SYSTEM FOR A POSITIVE DISPLACEMENT PUMP,” which in turn is a continuation of U.S. patent application Ser. No. 14/579,551 filed Dec. 22, 2014, and entitled “MECHANICAL DRIVE SYSTEM FOR A PULSELESS POSITIVE DISPLACEMENT PUMP,” now U.S. Pat. No. 10,161,393, which in turn claims the benefit of U.S. Provisional Application No. 62/022,263 filed on Jul. 9, 2014, and entitled “MECHANICALLY-DRIVEN DIAPHRAGM PUMP WITH DIAPHRAGM PRESSURE CHAMBER,” and to U.S. Provisional Application No. 61/937,266 filed on Feb. 7, 2014, and entitled “MECHANICALLY-DRIVEN DIAPHRAGM PUMP WITH DIAPHRAGM PRESSURE CHAMBER,” the disclosures of which are hereby incorporated by reference in their entireties.

### BACKGROUND

This disclosure relates to positive displacement pumps and more particularly to an internal drive system for positive displacement pumps.

Positive displacement pumps discharge a process fluid at a selected flow rate. In a typical positive displacement pump, a fluid displacement member, usually a piston or diaphragm, drives the process fluid through the pump. When the fluid displacement member is drawn in, a suction condition is created in the fluid flow path, which draws process fluid into a fluid cavity from the inlet manifold. The fluid displacement member then reverses direction and forces the process fluid out of the fluid cavity through the outlet manifold.

Air operated double displacement pumps typically employ diaphragms as the fluid displacement members. In an air operated double displacement pump, the two diaphragms are joined by a shaft, and compressed air is the working fluid in the pump. Compressed air is applied to one of two diaphragm chambers, associated with the respective diaphragms. When compressed air is applied to the first diaphragm chamber, the first diaphragm is deflected into the first fluid cavity, which discharges the process fluid from that fluid cavity. Simultaneously, the first diaphragm pulls the shaft, which is connected to the second diaphragm, drawing the second diaphragm in and pulling process fluid into the second fluid cavity. Delivery of compressed air is controlled by an air valve, and the air valve is usually actuated mechanically by the diaphragms. Thus, one diaphragm is pulled in until it causes the actuator to toggle the air valve. Toggling the air valve exhausts the compressed air from the first diaphragm chamber to the atmosphere and introduces fresh compressed air to the second diaphragm chamber, thus causing a reciprocating movement of the respective diaphragms. Alternatively, the first and second fluid displacement members could be pistons instead of diaphragms, and the pump would operate in the same manner.

Hydraulically driven double displacement pumps utilize hydraulic fluid as the working fluid, which allows the pump to operate at much higher pressures than an air driven pump. In a hydraulically driven double displacement pump, hydraulic fluid drives one fluid displacement member into a pumping stroke, while that fluid displacement member is mechanically attached to the second fluid displacement member and thereby pulls the second fluid displacement member into a suction stroke. The use of hydraulic fluid and pistons enables the pump to operate at higher pressures than an air driven diaphragm pump could achieve.

Alternatively, double displacement pumps may be mechanically operated, without the use of air or hydraulic fluid. In these cases, the operation of the pump is essentially similar to an air operated double displacement pump, except compressed air is not used to drive the system. Instead, a reciprocating drive is mechanically connected to both the first fluid displacement member and the second fluid displacement member, and the reciprocating drive drives the two fluid displacement members into suction and pumping strokes.

### SUMMARY

According to one embodiment of the present invention, a drive system for a pumping apparatus includes a housing, an internal pressure chamber filled with a working fluid and defined by the housing, and a fluid displacement member sealingly enclosing a first end of the internal pressure chamber. A reciprocating member is disposed within the internal pressure chamber, and the reciprocating member has a pull chamber. A pull is secured within the pull chamber and a fluid displacement member is coupled to the pull.

According to another embodiment, a drive system for a pumping apparatus includes a housing, an internal pressure chamber filled with a working fluid and defined by the housing, a reciprocating member disposed within the internal pressure chamber, and a plurality of fluid displacement members. The reciprocating member has a first pull chamber and a second pull chamber. A first pull is secured within the first pull chamber and a first one of the plurality of fluid displacement members is coupled to the first pull. A second pull is secured within the second pull chamber and a second one of the plurality of fluid displacement members is coupled to the second pull.

According to yet another embodiment, a drive system for a pumping apparatus comprises a housing, an internal pressure chamber filled with a working fluid and defined by the housing, and a fluid displacement member sealingly enclosing a first end of the internal pressure chamber. A drive extends into the internal pressure chamber, and a hub is disposed on the drive with an attachment member on the hub. A flexible belt is connected to the fluid displacement member and to the attachment portion.

Yet another embodiment of the present invention includes a drive system for a pumping apparatus that has a housing, an internal pressure chamber filled with a working fluid and defined by the housing, and a plurality of fluid displacement members. A drive extends into the internal pressure chamber, and a hub is disposed on the drive. The hub has a first attachment portion and a second attachment portion, and a first flexible belt is connected to a first one of the plurality of fluid displacement members and a second flexible belt is connected to a second one of the plurality of fluid displacement members.

### BRIEF DESCRIPTION OF THE DRAWINGS

FIG. 1 is a rear perspective view of a pump, drive system, and motor.

FIG. 2 is an exploded perspective view of a pump, drive system, and drive.

FIG. 3A is a cross-sectional view, along section 3-3 in FIG. 1, showing the connection of pump, drive system, and drive.

FIG. 3B is a cross-sectional view, along section 3-3 in FIG. 1, showing the connection of FIG. 3A during an over-pressurization event.

FIG. 4 is a top, cross-sectional view, along section 4-4 in FIG. 1, showing the connection of pump, drive system, and drive.

FIG. 5 is a cross-sectional view, along section 5-5 in FIG. 1, showing the connection of a pump, a drive system, and a drive.

FIG. 6 is a cross-sectional view, along section 6-6 in FIG. 1, showing the connection of a pump, a drive system, and a drive.

FIG. 7 is a cross-sectional view, along section 7-7 in FIG. 1, showing the connection of a pump, a drive system, and a drive.

### DETAILED DESCRIPTION

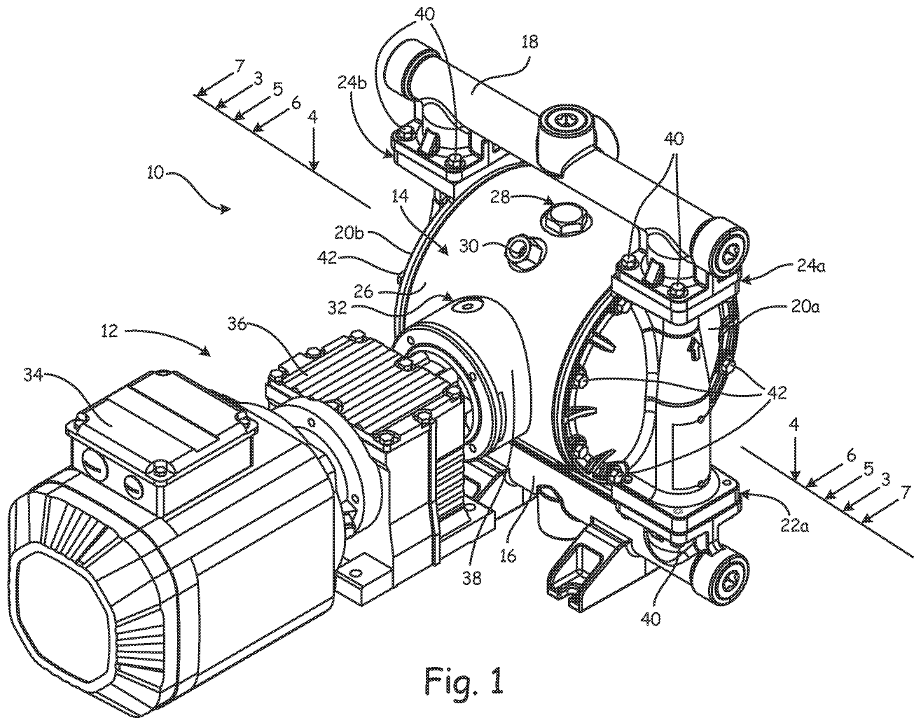

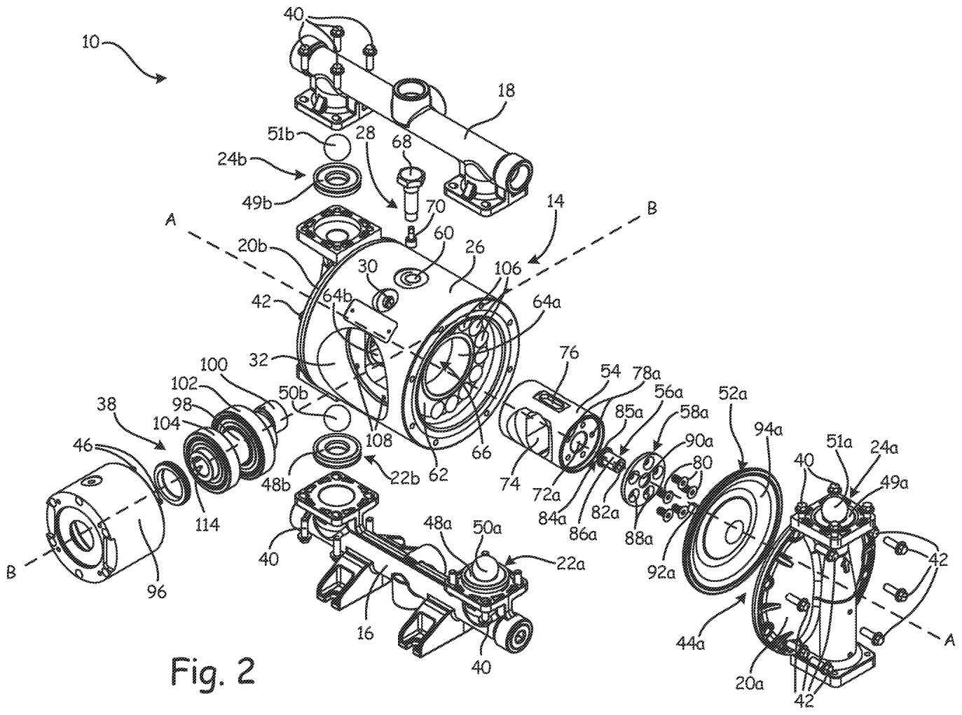

FIG. 1 shows a perspective view of pump 10, electric drive 12, and drive system 14. Pump 10 includes inlet manifold 16, outlet manifold 18, fluid covers 20a and 20b, inlet check valves 22a and 22b, and outlet check valves 24a and 24b. Drive system 14 includes housing 26 and piston guide 28. Housing includes working fluid inlet 30 and drive chamber 32 (best seen in FIG. 2). Electric drive 12 includes motor 34, gear reduction drive 36, and drive 38.

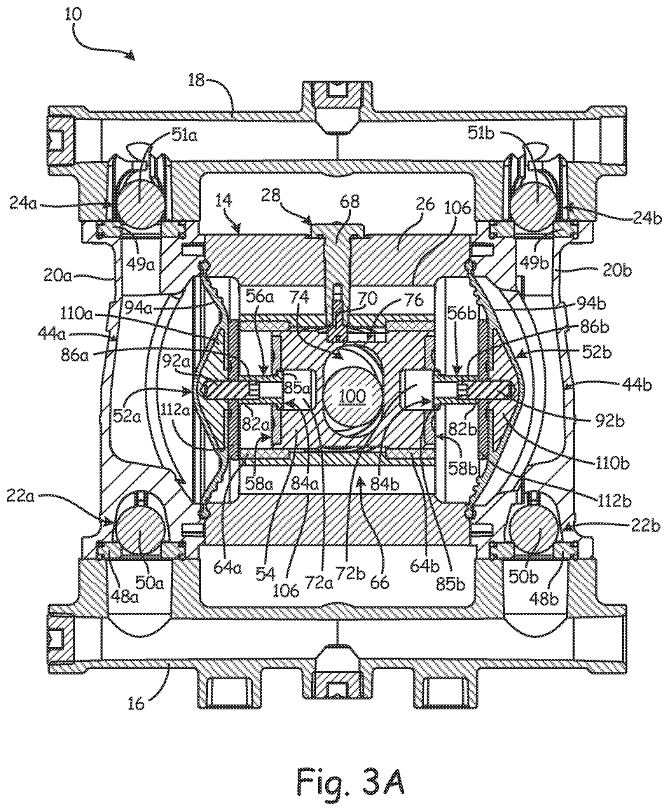

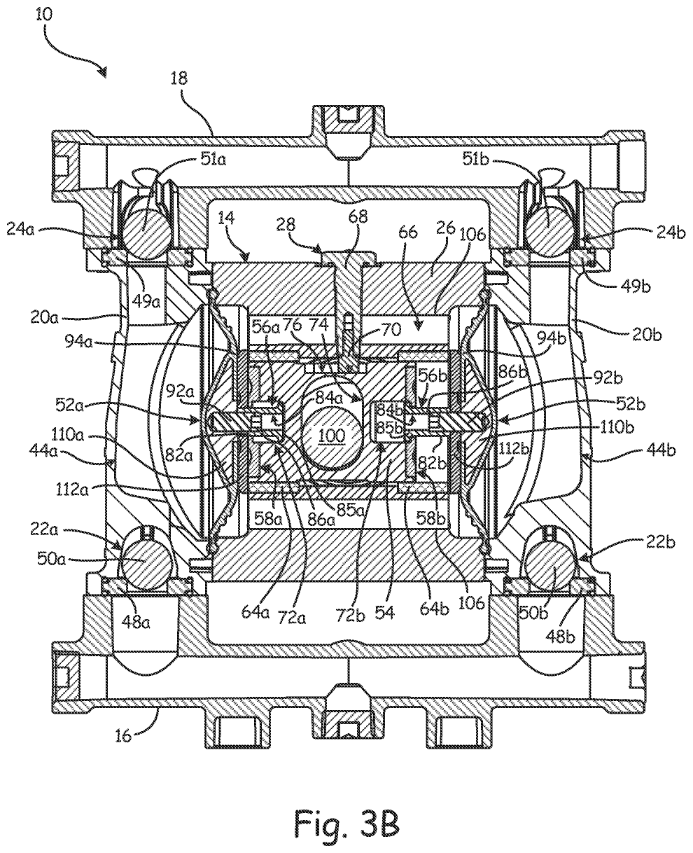

Fluid covers 20a and 20b are attached to inlet manifold 16 by fasteners 40. Inlet check valves 22a and 22b (shown in FIG. 2) are disposed between inlet manifold 16 and fluid covers 20a and 20b respectively. Fluid covers 20a and 20b are similarly attached to outlet manifold 18 by fasteners 40. Outlet check valves 24a and 24b (shown in FIG. 2) are disposed between outlet manifold 18 and fluid covers 20a and 20b, respectively. Housing 26 is secured between fluid covers 20a and 20b by fasteners 42. Fluid cavity 44a (best seen in FIG. 3) is formed between housing 26 and fluid cover 20a. Fluid cavity 44b (best seen in FIG. 3) is formed between housing 26 and fluid cover 20b.

Motor 34 is attached to and drives gear reduction drive 36. Gear reduction drive 36 drives drive 38 to actuate pump 10. Drive 38 is secured within drive chamber 32 by fasteners 46.

Housing 26 is filled with a working fluid, either a gas, such as compressed air, or a non-compressible hydraulic fluid, through working fluid inlet 30. When the working fluid is a non-compressible hydraulic fluid, housing 26 further includes an accumulator for storing a portion of the non-compressible hydraulic fluid during an overpressurization event. As explained in more detail below, drive 38 causes drive system 14 to draw process fluid from inlet manifold 16 into either fluid cavity 44a or fluid cavity 44b. The working fluid then discharges the process fluid from either fluid cavity 44a or fluid cavity 44b into outlet manifold 18. Inlet check valves 22a and 22b prevent the process fluid from backflowing into inlet manifold 16 while the process fluid is being discharged to outlet manifold 18. Similarly, outlet check valves 24a and 24b prevent the process fluid from backflowing into either fluid cavity 44a or 44b from outlet manifold 18.

FIG. 2 is an exploded, perspective view of pump 10, drive system 14, and drive 38. Pump 10 includes inlet manifold 16, outlet manifold 18, fluid covers 20a and 20b, inlet check valves 22a and 22b, and outlet check valves 24a and 24b. Inlet check valve 22a includes seat 48a and check ball 50a, and inlet check valve 22b includes seat 48b and check ball 50b. Similarly, outlet check valve 24a include seat 49a and check ball 51a, and outlet check valve 24b includes seat 49b and check ball 51b. Although inlet check valves 22a/22b and outlet check valves 24a/24b are shown as ball check valves, inlet check valves 22a/22b and outlet check valves 24a/24b can be any suitable valve for preventing the backflow of process fluid.

Pump further includes fluid displacement members 52a and 52b. In the present embodiment, fluid displacement members 52a and 52b are shown as diaphragms, but fluid displacement members 52a and 52b could be diaphragms, pistons, or any other suitable device for displacing process fluid. Additionally, while pump 10 is described as a double displacement pump, utilizing dual diaphragms, it is understood that drive system 14 could similarly drive a single displacement pump without any material change. It is also understood that drive system 14 could drive a pump with more than two fluid displacement members.

Drive system 14 includes housing 26, piston guide 28, piston 54, pulls 56a and 56b, and face plates 58a and 58b. Housing 26 includes working fluid inlet 30, guide opening 60, annular structure 62, and bushings 64a and 64b. Housing 26 defines internal pressure chamber 66, which contains the working fluid during operation. In the present embodiment, the reciprocating member of drive system 14 is shown as a piston, but it is understood that the reciprocating member of drive system 14 could be any suitable device for creating a reciprocating motion, such as a scotch yoke or any other drive suitable for reciprocating within housing 26.

Piston guide 28 includes barrel nut 68 and guide pin 70. Piston 54 includes pull chamber 72a disposed within a first end of piston 54 and pull chamber 72b (shown in FIG. 3A) disposed within a second end of piston 54. Piston 54 further includes central slot 74, axial slot 76, and openings 78a and 78b (not shown) for receiving face plate fasteners 80. Pull 56a is identical to pull 56b with like numbers indicating like parts. Pull 56a includes attachment end 82a, free end 84a, and pull shaft 86a extending between attachment end 82a and free end 84a. Free end 84a of pull 56a includes flange 85a. Face plate 58a is identical to face plate 58b with like numbers indicating like parts. Face plate 58a includes fastener holes 88a and pull opening 90a. In the present embodiment, fluid displacement member 52a includes attachment screw 92a and diaphragm 94a. Drive 38 includes housing 96, crank shaft 98, cam follower 100, bearing 102, and bearing 104. Annular structure 62 includes openings 106 therethrough.

Inlet manifold 16 is attached to fluid cover 20a by fasteners 40. Inlet check valve 22a is disposed between inlet manifold 16 and fluid cover 20a. Seat 48a of inlet check valve 22a sits upon inlet manifold 16, and check ball 50a of inlet check valve 22a is disposed between seat 48a and fluid cover 20a. Similarly, inlet manifold 16 is attached to fluid cover 20b by fasteners 40, and inlet check valve 22b is disposed between inlet manifold 16 and fluid cover 20b. Outlet manifold 18 is attached to fluid cover 20a by fasteners 40. Outlet check valve 24a is disposed between outlet manifold 18 and fluid cover 20a. Seat 49a of outlet check valve 24a sits upon fluid cover 20a and check ball 51a of outlet check valve 24a is disposed between seat 49a and outlet manifold 18. Similarly, outlet manifold 18 is attached to fluid cover 20b by fasteners 40, and outlet check valve 24b is disposed between outlet manifold 18 and fluid cover 20b.

Fluid cover 20a is fixedly attached to housing 26 by fasteners 42. Fluid displacement member 52a is secured between housing 26 and fluid cover 20a to define fluid cavity 44a and sealingly encloses one end of internal pressure chamber 66. Fluid cover 20b is fixedly attached to housing 26 by fasteners 42, and fluid displacement member 52b is secured between housing 26 and fluid cover 20b. Similar to fluid cavity 44a, fluid cavity 44b is formed by fluid cover 20b and fluid displacement member 52b, and fluid displacement member 52b sealingly encloses a second end of internal pressure chamber 66.

Bushings 64a and 64b are disposed upon annular structure 62, and piston 54 is disposed within housing 26 and rides upon bushings 64a and 64b. Barrel nut 68 extends through and is secured within guide opening 60. Guide pin 70 is fixedly secured to barrel nut 68 and rides within axial slot 76 to prevent piston 54 from rotating about axis A-A. Free end 84a of pull 56a is slidably disposed within pull chamber 72a of piston 54. Pull shaft 86a extends through pull opening 90a of face plate 58a. Face plate 58a is secured to piston 54 by face plate fasteners 80 that extend through openings 88a and into fastener holes 78a of piston 54. Pull opening 90a is sized such that pull shaft 86a can slide through pull opening 90a but free end 84a is retained within pull chamber 72a by flange 85a engaging face plate 58a. Attachment end 82a is secured to attachment screw 92a to join fluid displacement member 52a to pull 56a.

Crank shaft 98 is rotatably mounted within housing 96 by bearing 102 and bearing 104. Cam follower 100 is affixed to crank shaft 98 such that cam follower 100 extends into housing 26 and engages central slot 74 of piston 54 when drive 38 is mounted to housing 26. drive 38 is mounted within drive chamber 32 of housing 26 by fasteners 46 extending through housing 96 and into fastener holes 108.

Internal pressure chamber 66 is filled with a working fluid, either compressed gas or non-compressible hydraulic fluid, through working fluid inlet 30. Openings 106 allow the working fluid to flow throughout internal pressure chamber 66 and exert force on both fluid displacement member 52a and fluid displacement member 52b.

Cam follower 100 reciprocatingly drives piston 54 along axis A-A. When piston 54 is displaced towards fluid displacement member 52a, pull 56b is pulled in the same direction due to flange 85b on free end 84b of pull 56b engaging face plate 58b. Pull 56b thereby pulls fluid displacement member 52b into a suction stroke. Pulling fluid displacement member 52b causes the volume of fluid cavity 44b to increase, which draws process fluid into fluid cavity 44b from inlet manifold 16. Outlet check valve 24b prevents process fluid from being drawn into fluid cavity 44b from outlet manifold 18 during the suction stroke. At the same time that process fluid is being drawn into fluid cavity 44b, the charge pressure of the working fluid in internal pressure chamber 66 pushes fluid displacement member 52a into fluid cavity 44a, causing fluid displacement member 52a to begin a pumping stroke. Pushing fluid displacement member 52a into fluid cavity 44a reduces the volume of fluid cavity 44a and causes process fluid to be expelled from fluid cavity 44a into outlet manifold 18. Inlet check valve 22a prevents process fluid from being expelled into inlet manifold 16 during a pumping stoke. When cam follower 100 causes piston 54 to reverse direction, fluid displacement member 52a is pulled into a suction stroke by pull 56a, and fluid displacement member 52b is pushed into a pumping stroke by the charge pressure of the working fluid in internal pressure chamber 66, thereby completing a pumping cycle.

Pull chambers 72a and 72b prevent piston 54 from exerting a pushing force on either fluid displacement member 52a or 52b. If the pressure in the process fluid exceeds the pressure in the working fluid, the working fluid will not be able to push either fluid displacement member 52a or 52b into a pumping stroke. In that overpressure situation, such as when outlet manifold 18 is blocked, drive 38 will continue to drive piston 54, but pulls 56a and 56b will remain in a suction stroke because the pressure of the working fluid is insufficient to cause either fluid displacement member 52a or 52b to enter a pumping stroke. When piston 54 is displaced towards fluid displacement member 52a, pull chamber 72a prevents pull 56a from exerting any pushing force on fluid displacement member 52a by housing pull 56a within pull chamber 72a. Allowing piston 54 to continue to oscillate without pushing either fluid displacement member 52a or 52b into a pumping stroke allows pump 10 to continue to run when outlet manifold 18 is blocked without causing any harm to the motor or pump.

FIG. 3A is a cross-sectional view of pump 10, drive system 14, and cam follower 100 during normal operation. FIG. 3B is a cross-sectional view of pump 10, drive system 14, and cam follower 100 after outlet manifold 18 has been blocked, i.e. the pump 10 has been deadheaded. FIG. 3A and FIG. 3B will be discussed together. Pump 10 includes inlet manifold 16, outlet manifold 18, fluid covers 20a and 20b, inlet check valves 22a and 22b, outlet check valves 24a and 24b, and fluid displacement members 52a and 52b. Inlet check valve 22a includes seat 48a and check ball 50a, while inlet check valve 22b similarly includes seat 48b and check ball 50b. Outlet check valve 24a includes seat 49a and check ball 51a, and outlet check valve 24b includes seat 49b and check ball 51b. In the present embodiment, fluid displacement member 52a includes diaphragm 94a, first diaphragm plate 110a, second diaphragm plate 112a, and attachment screw 92a. Similarly, fluid displacement member 52b includes diaphragm 94b, first diaphragm plate 110b, second diaphragm plate 112b, and attachment screw 92b.

Drive system 14 includes housing 26, piston guide 28, piston 54, pulls 56a and 56b, face plates 58a and 58b, annular structure 62, and bushings 64a and 64b. Housing 26 includes guide opening 60 for receiving piston guide 28 therethrough, and housing 26 defines internal pressure chamber 66. Piston guide 28 includes barrel nut 68 and guide pin 70. Piston 54 includes pull chambers 72a and 72b, central slot 74 and axial slot 76. Pull 56a includes attachment end 82a, free end 84a and pull shaft 86a extending between free end 84a and attachment end 82a. Free end 84a includes flange 85a. Similarly, pull 56b includes attachment end 82b, free end 84b, and pull shaft 86b, and free end 84b includes flange 85b. Face plate 58a includes pull opening 90a and face plate 58b includes opening 90b.

Fluid cover 20a is affixed to housing 26, and fluid displacement member 52a is secured between fluid cover 20a and housing 26. Fluid cover 20a and fluid displacement member 52a define fluid cavity 44a. Fluid displacement member 52a also sealingly separates fluid cavity 44a from internal pressure chamber 66. Fluid cover 20b is affixed to housing 26 opposite fluid cover 20a. Fluid displacement member 52b is secured between fluid cover 20b and housing 26. Fluid cover 20b and fluid displacement member 52b define fluid cavity 44b, and fluid displacement member 52b sealingly separates fluid cavity 44b from internal pressure chamber 66.

Piston 54 rides on bushings 64a and 64b. Free end 84a of pull 56a is slidably secured within pull chamber 72a of piston 54 by flange 85a and face plate 58a. Flange 85a engages face plate 58a and prevents free end 84a from exiting pull chamber 72a. Pull shaft 86a extends through opening 90a, and attachment end 82a engages attachment screw 92a. In this way, attaches fluid displacement member 52a to piston 54. Similarly, free end 84b of pull 56b is slidably secured within pull chamber 72b of piston 54 by flange 85b and face plate 58b. Pull shaft 86b extends through pull opening 90b, and attachment end 82b engages attachment screw 92b.

Cam follower 100 engages central slot 74 of piston 54. Barrel nut 68 extends through guide opening 60 into internal pressure chamber 66. Guide pin 70 is attached to the end of barrel nut 68 that projects into internal pressure chamber 66, and guide pin 70 slidably engages axial slot 76.

Inlet manifold 16 is attached to both fluid cover 20a and fluid cover 20b. Inlet check valve 22a is disposed between inlet manifold 16 and fluid cover 20a, and inlet check valve 22b is disposed between inlet manifold 16 and fluid cover 20b. Seat 48a rests on inlet manifold 16 and check ball 50a is disposed between seat 48a and fluid cover 20a. Similarly, seat 48b rests on inlet manifold 16 and check ball 50b is disposed between seat 48b and fluid cover 20b. In this way, inlet check valves 22a and 22b are configured to allow process fluid to flow from inlet manifold 16 into either fluid cavity 44a and 44b, while preventing process fluid from backflowing into inlet manifold 16 from either fluid cavity 44a or 44b.

Outlet manifold 18 is also attached to both fluid cover 20a and fluid cover 20b. Outlet check valve 24a is disposed between outlet manifold 18, and fluid cover 20a, and outlet check valve 24b is disposed between outlet manifold 18 and fluid cover 20b. Seat 49a rests upon fluid cover 20a and check ball 51a is disposed between seat 49a and outlet manifold 18. Similarly, seat 49b rests upon fluid cover 20b and check ball 51b is disposed between seat 49b and outlet manifold 18. Outlet check valves 24a and 24b are configured to allow process fluid to flow from fluid cavity 44a or 44b into outlet manifold 18, while preventing process fluid from backflowing into either fluid cavity 44a or 44b from outlet manifold 18.

Cam follower 100 reciprocates piston 54 along axis A-A. Piston guide 28 prevents piston 54 from rotating about axis A-A by having guide pin 70 slidably engaged with axial slot 76. When piston 54 is drawn towards fluid cavity 44b, pull 56a is also pulled towards fluid cavity 44b due to flange 85a engaging face plate 58a. Pull 56a thereby causes fluid displacement member 52a to enter a suction stroke due to the attachment of attachment end 82a and attachment screw 92a. Pulling fluid displacement member 52a causes the volume of fluid cavity 44a to increase, which draws process fluid through check valve 22a and into fluid cavity 44a from inlet manifold 16. Outlet check valve 24a prevents process fluid from being drawn into fluid cavity 44a from outlet manifold 18 during the suction stroke.

At the same time that process fluid is being drawn into fluid cavity 44a, the working fluid causes fluid displacement member 52b to enter a pumping stroke. The working fluid is charged to a higher pressure than that of the process fluid, which allows the working fluid to displace the fluid displacement member 52a or 52b that is not being drawn into a suction stroke by piston 54. Pushing fluid displacement member 52b into fluid cavity 44b reduces the volume of fluid cavity 44b and causes process fluid to be expelled from fluid cavity 44b through outlet check valve 24b and into outlet manifold 18. Inlet check valve 22b prevents process fluid from being expelled into inlet manifold 16 during a pumping stoke.

When cam follower 100 causes piston 54 to reverse direction and travel towards fluid cavity 44a, face plate 58b catches flange 85b on free end 84b of pull 56b. Pull 56b then pulls fluid displacement member 52b into a suction stroke causing process fluid to enter fluid cavity 44b through check valve 22b from inlet manifold 16. At the same time, the working fluid now causes fluid displacement member 52a to enter a pumping stroke, thereby discharging process fluid from fluid cavity 44a through check valve 24a and into outlet manifold 18.

A constant downstream pressure is produced to eliminate pulsation by sequencing the speed of piston 54 with the pumping stroke caused by the working fluid. To eliminate pulsation, piston 54 is sequenced such that when it begins to pull one of fluid displacement member 52a or 52b into a suction stroke, the other fluid displacement member 52a or 52b has already completed its change-over and started a pumping stroke. Sequencing the suction and pumping strokes in this way prevents the drive system 14 from entering a state of rest.

Referring specifically to FIG. 3B, pull chamber 72a and pull chamber 72b of piston 54 allow pump 10 to be deadheaded without causing any damage to the pump 10 or motor 12. When pump 10 is deadheaded, the process fluid pressure exceeds the working fluid pressure, which prevents the working fluid from pushing either fluid displacement member 52a or 52b into a pumping stroke.

During over-pressurization fluid displacement member 52a and fluid displacement member 52b are retracted into a suction stroke by piston 54; however, because the working fluid pressure is insufficient to push the fluid displacement member 52a or 52b into a pumping stroke, the fluid displacement members 52a and 52b remain in the suction stroke position. Piston 54 is prevented from mechanically pushing either fluid displacement member 52a or 52b into a pumping stroke by pull chamber 72a, which houses pull 56a when the process fluid pressure exceeds the working fluid pressure and piston 54 is driven towards fluid displacement member 52a, and pull chamber 72b, which houses pull 56b when the process fluid pressure exceeds the working fluid pressure and piston 54 is driven towards fluid displacement member 52b. Housing pull 56a within pull chamber 72a and pull 56b within pull chamber 72b prevents piston 54 from exerting any pushing force on fluid displacement members 52a or 52b, which allows outlet manifold 18 to be blocked without damaging pump 10.

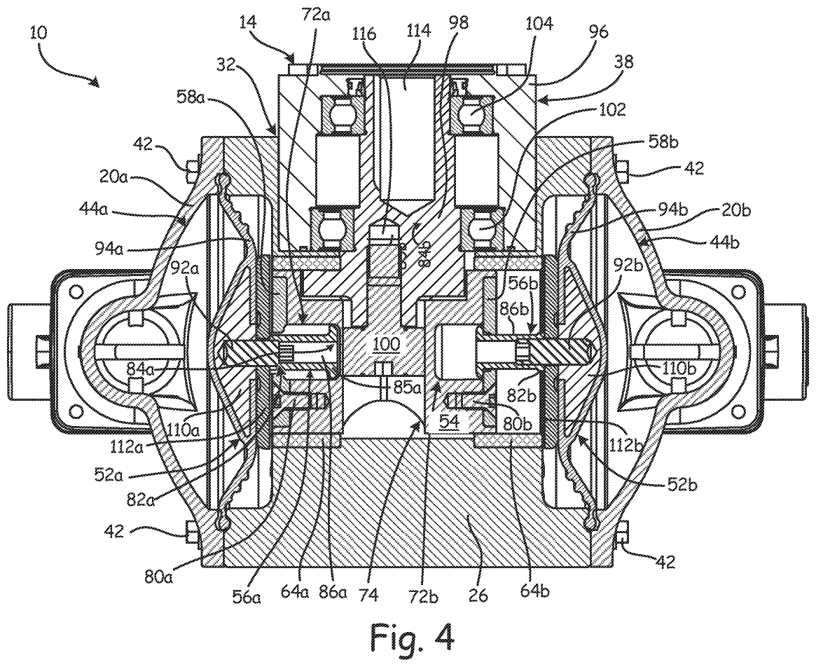

FIG. 4 is a top cross-sectional view, along line 4-4 of FIG. 1, showing the connection of drive system 14 and drive 38. FIG. 4 also depicts fluid covers 20a and 20b, and fluid displacement members 52a and 52b. Drive system 14 includes housing 26, piston 54, pulls 56a and 56b, face plates 58a and 58b, and bushings 64a and 64b. Housing 26 and fluid displacement members 52a and 52b define internal pressure chamber 66. Housing 26 includes drive chamber 32 and annular structure 62. Piston 54 includes pull chambers 72a and 72b and central slot 74. Pull 56a includes attachment end 82a, free end 84a, flange 85a, and pull shaft 86a, while pull 56b similarly includes attachment end 82b, free end 84b, flange 85b, and shaft 86b. Face plate 58a includes pull opening 90a and openings 88a. Similarly, face plate 58b includes pull opening 90b and openings 88b. In the present embodiment, drive 38 includes housing 96, crank shaft 98, cam follower 100, bearing 102, and bearing 104. Crank shaft 98 includes drive shaft chamber 114 and cam follower chamber 116.

Fluid cover 20a is attached to housing 26 by fasteners 42. Fluid displacement member 52a is secured between fluid cover 20a and housing 26. Fluid cover 20a and fluid displacement member 52a define fluid cavity 44a. Similarly, fluid cover 20b is attached to housing 26 by fasteners 42, and fluid displacement member 52b is secured between fluid cover 20b and housing 26. Fluid cover 20b and fluid displacement member 52b define fluid cavity 44b. Housing 26 and fluid displacement members 52a and 52b define internal pressure chamber 66.

In the present embodiment, fluid displacement member 52a is shown as a diaphragm and includes diaphragm 94a, first diaphragm plate 110a, second diaphragm plate 112a, and attachment screw 92a. Similarly, fluid displacement member 52b is shown as a diaphragm and includes diaphragm 94b, first diaphragm plate 110b, second diaphragm plate 112b, and attachment screw 92b. While fluid displacement members 52a and 52b are shown as diaphragms, it is understood that fluid displacement members 52a and 52b could also be pistons.

Piston 54 is mounted on bushings 64a and 64b within internal pressure chamber 66. Free end 84a of pull 56a is slidably secured within pull chamber 72a by face plate 58a and flange 85a. Shaft 86a extends through opening 90a, and attachment end 82a engages attachment screw 92a. Face plate 58a is secured to piston 54 by face plate fasteners 80a extending through openings 88a and into piston 54. Similarly, free end 84b of pull 56b is slidably secured within pull chamber 72b by face plate 58b and flange 85b. Pull shaft 86b extends through pull opening 90b, and attachment end 82b engages attachment screw 92b. Face plate 58b is attached to piston 54 by face plate fasteners 80b extending through openings 88b and into piston 54.

Drive 38 is mounted within drive chamber 32 of housing 26. Crank shaft 98 is rotatably mounted within housing 96 by bearing 102 and bearing 104. Crank shaft 98 is driven by a drive shaft (not shown) that connects to crank shaft 98 at drive shaft chamber 114. Cam follower 100 is mounted to crank shaft 98 opposite the drive shaft, and cam follower 100 is mounted at cam follower chamber 116. Cam follower 100 extends into internal pressure chamber 66 and engages central slot 74 of piston 54.

Drive 38 is driven by electric motor 12 (shown in FIG. 1), which rotates crank shaft 98 on bearings 102 and 104. Crank shaft 98 thereby rotates cam follower 100 about axis B-B, and cam follower 100 thus causes piston 54 to reciprocate along axis A-A. Because piston 54 has a predetermined lateral displacement, determined by the rotation of cam follower 100, the speed of the piston 54 can be sequenced with the pressure of the working fluid to eliminate downstream pulsation.

When cam follower 100 drives piston 54 towards fluid displacement member 52b, piston 54 pulls fluid displacement member 52a into a suction stroke via pull 56a. Flange 85a of pull 56a engages face plate 58a such that piston 54 causes pull 56a to also move towards fluid displacement member 52b, which causes pull 56a to pull fluid displacement member 52a into a suction stroke. Pull 56a pulls fluid displacement member 52a into a suction stroke through attachment end 82a being engaged with attachment screw 92a. At the same time, the pressurized working fluid within internal pressure chamber 66 pushes fluid displacement member 52b into a pumping stroke.

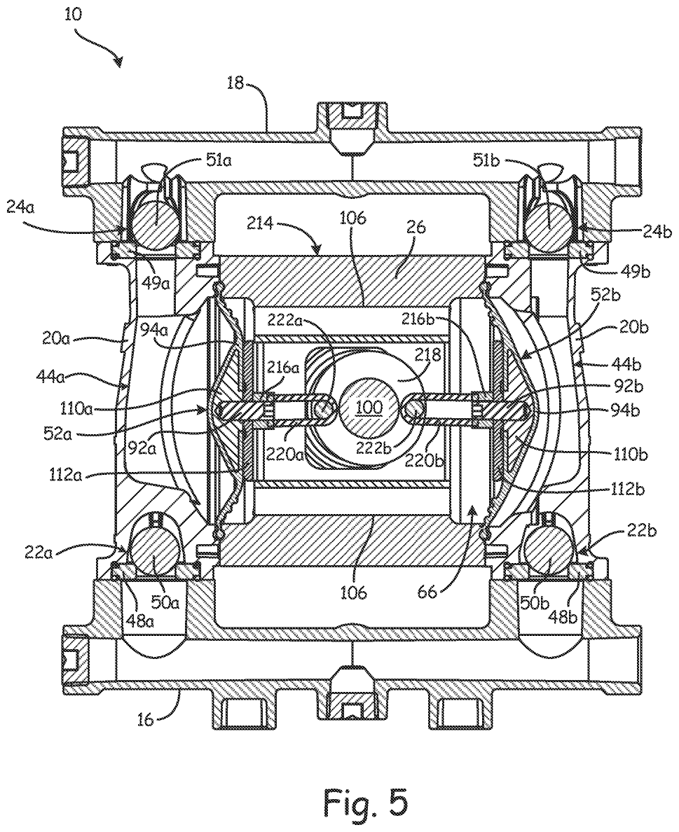

FIG. 5 is a cross-sectional view, along section 5-5 of FIG. 1, showing the connection of pump 10, drive system 214, and cam follower 100. Pump 10 includes inlet manifold 16, outlet manifold 18, fluid covers 20a and 20b, inlet check valves 22a and 22b, outlet check valves 24a and 24b, and fluid displacement members 52a and 52b. Inlet check valve 22a includes seat 48a and check ball 50a, while inlet check valve 22b includes seat 48b and check ball 50b. Outlet check valve 24a includes seat 49a and check ball 51a, while outlet check valve 24b includes seat 49b and check ball 51b. In the present embodiment, fluid displacement member 52a includes diaphragm 94a, first diaphragm plate 110a, second diaphragm plate 112a, and attachment member 216a. Similarly, fluid displacement member 52b includes diaphragm 94b, first diaphragm plate 110b, second diaphragm plate 112b, and attachment member 216b. Drive system 214 includes housing 26, hub 218, flexible belts 220a and 220b, and pins 222a and 222b. Housing 26 defines internal pressure chamber 66.

Fluid cover 20a is affixed to housing 26, and fluid displacement member 52a is secured between fluid cover 20a and housing 26. Fluid cover 20a and fluid displacement member 52a define fluid cavity 44a, and fluid displacement member 52a sealingly separates fluid cavity 44a and internal pressure chamber 66. Fluid cover 20b is affixed to housing 26, and fluid displacement member 52b is secured between fluid cover 20b and housing 26. Fluid cover 20b and fluid displacement member 52b define fluid cavity 44b, and fluid displacement member 52b sealingly separates fluid cavity 44b and internal pressure chamber 66. Housing 26 includes openings 106 to allow working fluid to flow within internal pressure chamber 66.

Hub 218 is press-fit to cam follower 100. Pin 222a projects from a periphery of hub 218 along axis B-B. Similarly, pin 222b projects from a periphery of hub 218 along axis B-B and opposite pin 222a. Flexible belt 220a is attached to pin 222a and to attachment member 216a. Flexible belt 220b is attached to pin 222b and to attachment member 216b.

Cam follower 100 drives hub 218 along axis A-A. When hub 218 is drawn towards fluid cavity 44b, flexible belt 220a is also pulled towards fluid cavity 44b causing fluid displacement member 52a to enter a suction stroke due to the attachment of flexible belt 220a to attachment member 216a and pin 222a. Pulling fluid displacement member 52a causes the volume of fluid cavity 44a to increase, which draws process fluid through check valve 22a and into fluid cavity 44a from inlet manifold 16. Outlet check valve 24a prevents process fluid from being drawn into fluid cavity 44a from outlet manifold 18 during the suction stroke.

At the same time that process fluid is being drawn into fluid cavity 44a, the working fluid causes fluid displacement member 52b to enter a pumping stroke. The working fluid is charged to a higher pressure than that of the process fluid, which allows the working fluid to displace the fluid displacement member 52a or 52b that is not being drawn into a suction stroke by hub 218. Pushing fluid displacement member 52b into fluid cavity 44b reduces the volume of fluid cavity 44b and causes process fluid to be expelled from fluid cavity 44b through outlet check valve 24b and into outlet manifold 18. Inlet check valve 22b prevents process fluid from being expelled into inlet manifold 16 during a pumping stoke.

When cam follower 100 causes hub 218 to reverse direction and travel towards fluid cavity 44a pin 222b engages flexible belt 220b, and flexible belt 220b then pulls fluid displacement member 52b into a suction stroke causing process fluid to enter fluid cavity 44b from inlet manifold 16. At the same time, the working fluid now causes fluid displacement member 52a to enter a pumping stroke, thereby discharging process fluid from fluid cavity 44a through check valve 24a and into outlet manifold 18.

Flexible belts 220a and 220b allow outlet manifold 18 of pump 10 to be blocked during the operation of pump 10 without risking damage to pump 10, drive system 214, or electric motor 12 (shown in FIG. 1). When outlet manifold 18 is blocked, the pressure in fluid cavity 44a and fluid cavity 44b equals the pressure of the working fluid in internal pressure chamber 66. When such an over-pressure situation occurs, hub 218 will draw both fluid displacement member 52a and fluid displacement member 52b into a suction stroke. However, drive system 214 cannot push either fluid displacement member 52a or 52b into a pumping stroke because flexible belts 220a and 220b are not sufficiently rigid to impart a pushing force on either fluid displacement member 52a or 52b.

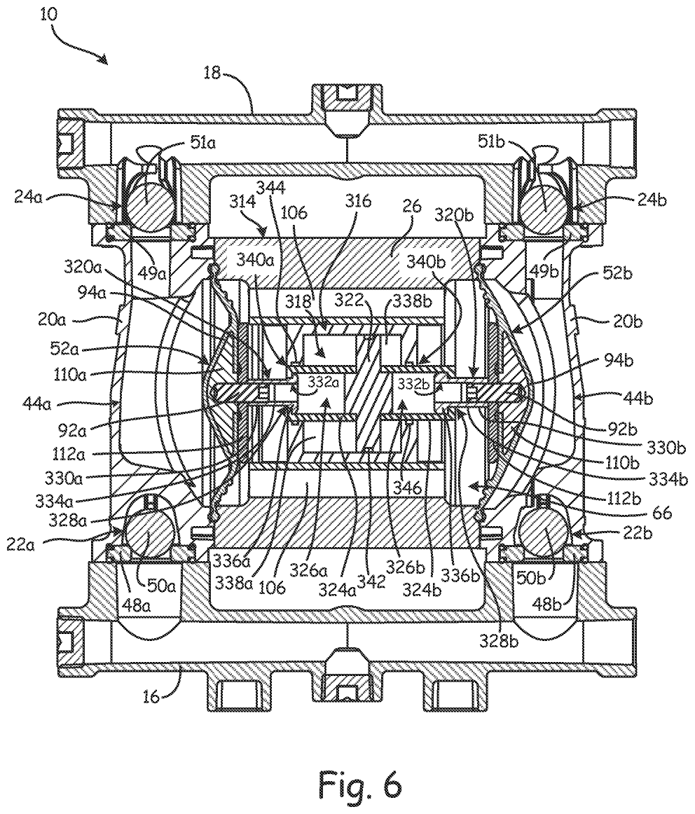

FIG. 6 is a cross-sectional view, along section 6-6 of FIG. 1, showing the connection of pump 10 and drive system 314. Pump 10 includes inlet manifold 16, outlet manifold 18, fluid covers 20a and 20b, inlet check valves 22a and 22b, outlet check valves 24a and 24b, and fluid displacement members 52a and 52b. Inlet check valve 22a includes seat 48a and check ball 50a, while inlet check valve 22b includes seat 48b and check ball 50b. Outlet check valve 24a includes seat 49a and check ball 51a, while outlet check valve 24b includes seat 49b and check ball 51b. In the present embodiment, fluid displacement member 52a includes diaphragm 94a, first diaphragm plate 110a, and second diaphragm plate 112a, and attachment screw 92a. Similarly, fluid displacement member 52b includes diaphragm 94b, first diaphragm plate 110b, and second diaphragm plate 112b, and attachment screw 92b.

Drive system 314 includes housing 26, second housing 316, piston 318, and pulls 320a and 320b. Piston 318 includes reciprocating member 322 and pull housings 324a and 324b. Pull housing 324a defines pull chamber 326a and includes pull opening 328a. Pull housing 324b defines pull chamber 326b and includes pull opening 328b. Pull 320a includes attachment end 330a, free end 332a and pull shaft 334a extending between free end 332a and attachment end 330a. Free end 332a includes flange 336a. Similarly, pull 320b includes attachment end 330b, free end 332b, and pull shaft 334b extending between free end 332b and attachment end 330b, and free end 332b includes flange 336b. Second housing 316 includes pressure chamber 338a and pressure chamber 338b, aperture 340a, aperture 340b, first o-ring 342, second o-ring 344, and third o-ring 346.

Fluid cover 20a is affixed to housing 26, and fluid displacement member 52a is secured between fluid cover 20a and housing 26. Fluid cover 20a and fluid displacement member 52a define fluid cavity 44a, and fluid displacement member 52a sealingly separates fluid cavity 44a and internal pressure chamber 66. Fluid cover 20b is affixed to housing 26, and fluid displacement member 52b is secured between fluid cover 20b and housing 26. Fluid cover 20b and fluid displacement member 52b define fluid cavity 44b, and fluid displacement member 52b sealingly separates fluid cavity 44b and internal pressure chamber 66.

Second housing 316 is disposed within housing 26. Piston 318 is disposed within second housing 316. First o-ring 342 is disposed around reciprocating member 322, and first o-ring 342 and reciprocating member 322 sealingly separate pressure chamber 338a and pressure chamber 338b. Pull housing 324a extends from reciprocating member 322 through aperture 340a and into internal pressure chamber 66. Pull housing 324b extends from reciprocating member 322 through aperture 340b and into internal pressure chamber 66. Second o-ring 344 is disposed around pull housing 324a at aperture 340a. Second o-ring 344 sealingly separates pressure chamber 338a from internal pressure chamber 66. Third o-ring 346 is disposed around pull housing 324b at aperture 340b. Third o-ring 346 sealingly separates pressure chamber 338b from internal pressure chamber 66.

Free end 332a of pull 320a is slidably secured within pull chamber 326a by flange 336a. Pull shaft 334a extends through pull opening 328a, and attachment end 330a engages attachment screw 92a. Similarly, free end 332b of pull 320b is slidably secured within pull chamber 326b by flange 336b. Pull shaft 334b extends through pull opening 328b, and attachment end 330b engages attachment screw 92b.

Piston 318 is reciprocatingly driven within second housing 316 by alternatingly providing pressurized fluid to pressure chamber 338a and pressure chamber 338b. The pressurized fluid can be compressed air, non-compressible hydraulic fluid, or any other fluid suitable for driving piston 318. First o-ring 342 sealingly separates pressure chamber 338a and pressure chamber 338b, which allows the pressurized fluid to reciprocatingly drive piston 318. When pressurized fluid is provided to pressure chamber 338a, second o-ring 344 sealingly separates the pressurized fluid from the working fluid disposed within internal pressure chamber 66. Similarly, when pressurized fluid is provided to pressure chamber 338b, third o-ring 346 sealingly separates the pressurized fluid from the working fluid disposed within internal pressure chamber 66.

When pressure chamber 338a is pressurized, piston 318 is driven towards fluid displacement member 52b. Pull 320a is thereby also drawn towards fluid displacement member 52b due to flange 336a engaging pull housing 324a. Pull 320a causes fluid displacement member 52a to enter into a suction stroke due to the connection between attachment end 330a and attachment screw 92a. At the same time, the working fluid in internal pressure chamber 66 pushes fluid displacement member 52b into a pumping stroke. During this stroke, pull chamber 326b prevents piston 318 from pushing fluid displacement member 52b into a pumping stroke.

The stroke is reversed when pressure chamber 338b is pressurized, thereby driving piston 318 towards fluid displacement member 52a. In this stroke, pull 320b is drawn towards fluid displacement member 52a due to flange 336b engaging pull housing 324b. Pull 320b causes fluid displacement member 52b to enter into a suction stroke due to the connection between attachment end 330b and attachment screw 92b. While fluid displacement member 52b is drawn into a suction stroke, the working fluid in internal pressure chamber 66 pushes fluid displacement member 52a into a pumping stroke. Similar to pull chamber 326b, pull chamber 326a prevents piston 318 from pushing fluid displacement member 52a into a pumping stroke.

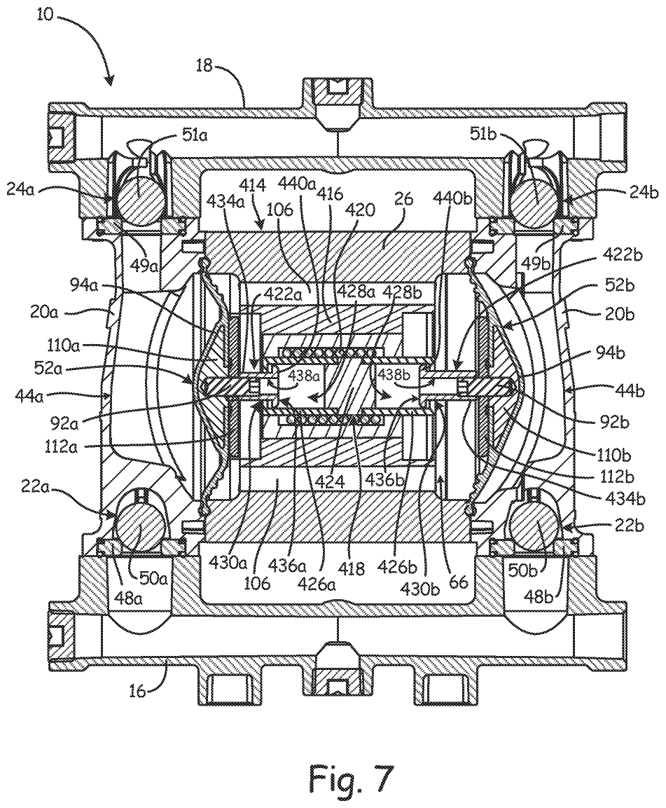

FIG. 7 is a cross-sectional view, along section 7-7 of FIG. 1, showing the connection of pump 10 and drive system 414. Pump 10 includes inlet manifold 16, outlet manifold 18, fluid covers 20a and 20b, inlet check valves 22a and 22b, outlet check valves 24a and 24b, and fluid displacement members 52a and 52b. Inlet check valve 22a includes seat 48a and check ball 50a, while inlet check valve 22b includes seat 48b and check ball 50b. Outlet check valve 24a includes seat 49a and check ball 51a, while outlet check valve 24b includes seat 49b and check ball 51b. In the present embodiment, fluid displacement member 52a includes diaphragm 94a, first diaphragm plate 110a, and second diaphragm plate 112a, and attachment screw 92a. Similarly, fluid displacement member 52b includes diaphragm 94b, first diaphragm plate 110b, and second diaphragm plate 112b, and attachment screw 92b.

Drive system 414 includes housing 26, second housing 416, reciprocating member 418, solenoid 420, and pulls 422a and 422b. Reciprocating member 418 includes armature 424 and pull housings 426a and 426b. Pull housing 426a defines pull chamber 428a and includes pull opening 430a. Pull housing 426b defines pull chamber 428b and includes pull opening 430b. Pull 422a includes attachment end 434a, free end 436a, and pull shaft 438a extending between attachment end 434a and free end 436a. Free end 436a includes flange 440a. Similarly, pull 422b includes attachment end 434b, free end 436b, and pull shaft 438b extending between attachment end 434b and free end 436b. Free end 436b includes flange 440b.

Fluid cover 20a is affixed to housing 26, and fluid displacement member 52a is secured between fluid cover 20a and housing 26. Fluid cover 20a and fluid displacement member 52a define fluid cavity 44a, and fluid displacement member 52a sealingly separates fluid cavity 44a and internal pressure chamber 66. Fluid cover 20b is affixed to housing 26, and fluid displacement member 52b is secured between fluid cover 20b and housing 26. Fluid cover 20b and fluid displacement member 52b define fluid cavity 44b, and fluid displacement member 52b sealingly separates fluid cavity 44b and internal pressure chamber 66.

Reciprocating member 418 is disposed within solenoid 420. Pull housing 426a is integrally attached to a first end armature 424, and pull housing 426b is integrally attached to a second end of armature 424 opposite pull housing 426a. Free end 436a of pull 422a is slidably secured within pull chamber 428a by flange 440a. Pull shaft 438a extends through pull opening 430a, and attachment end 434a engages attachment screw 92a. Similarly, free end 436b of pull 422b is slidably secured within pull chamber 428b by flange 440b. Pull shaft 438b extends through pull opening 430b, and attachment end 434b engages attachment screw 92b.

Solenoid 420 reciprocatingly drives armature 424, which thereby reciprocatingly drives pull housing 426a and pull housing 426b.

The strokes are reversed by solenoid 420 driving armature 424 in an opposite direction from the initial stroke. In this stroke, pull housing 426b engages flange 440b of pull 422b, and pull 422b thereby draws fluid displacement member 52b into a suction stroke. At the same time, the working fluid in internal pressure chamber 66 pushes fluid displacement member 52a into a pumping stroke. During the pumping stroke of fluid displacement member 52a, pull chamber 428a prevents pull 422a from exerting any pushing force on fluid displacement member 52a.

The pump 10 and drive system 14 described herein provide several advantages. Drive system 14 eliminates the need for downstream dampeners or surge suppressors because the drive system 14 provides a pulseless flow of process fluid when piston 54 is sequenced. Downstream pulsation is eliminated because when one fluid displacement member 52a or 52b is changing over from one stroke, the other fluid displacement member 52a or 52b is already displacing process fluid. This eliminates any rest within the pump 10, which eliminates pulsation because fluid is being constantly discharged, at a constant rate. So long as the working fluid pressure remains slightly greater than the process fluid pressure, the drive system 14 is self-regulating and provides a constant downstream flow rate.

The working fluid pressure determines the maximum process fluid pressures that occur when the downstream flow is blocked or deadheaded. If outlet manifold 18 is blocked, motor 12 can continue to run without damaging motor 12, drive system 14, or pump 10. Pull chambers 72a and 72b ensure that the drive system 14 will not cause over pressurization, by preventing piston 54 from exerting any pushing force on either fluid displacement member 52a or 52b. This also eliminates the need for downstream pressure relief valves, because the pump 10 is self-regulating and will not cause an over-pressurization event to occur. This pressure control feature serves as a safety feature and eliminates the possibility of over-pressurization of process fluids, potential pump damage, and excessive motor loads.

When drive system 14 is used with diaphragm pumps, the drive system 14 provides for equalized balanced forces on the diaphragms, from both the working fluid and the process fluid, which allows for longer diaphragm life and use with higher pressure applications over mechanically-driven diaphragm pumps. Pump 10 also provides better metering and dosing capabilities due to the constant pressure on and shape of fluid displacement members 52a and 52b.

When compressed air is used as the working fluid, drive system 14 eliminates the possibility of exhaust icing, as can be found in air-driven pumps, because the compressed air in drive system 14 is not exhausted after each stroke. Other exhaust problems are also eliminated, such as safety hazards that arise from exhaust becoming contaminated with process fluids. Additionally, higher energy efficiency can be achieved with drive system 14 because the internal pressure chamber 66 eliminates the need to provide a fresh dose of compressed air during each stroke, as is found in typical air operated pumps. When a non-compressible hydraulic fluid is used as the working fluid drive system 14 eliminates the need for complex hydraulic circuits with multiple compartments, as can be found in typical hydraulically driven pumps. Additionally, drive system 14 eliminates the contamination risk between the process fluid and the working fluid due to the balanced forces on either side of fluid displacement members 52a and 52b.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A drive system for a displacement pump, the drive system comprising:
a first housing at least partially defining an internal pressure chamber configured to be filled with a working fluid having a charge pressure;
a reciprocator disposed within the first housing and configured to be driven along a first axis;
a first diaphragm disposed at a first end of the first housing, the first diaphragm at least partially defining the internal pressure chamber;
a second diaphragm disposed at a second end of the first housing, the second diaphragm at least partially defining the internal pressure chamber;
wherein the reciprocator is connected to the first diaphragm and the second diaphragm to mechanically displace the first diaphragm through a first suction stroke and to mechanically displace the second diaphragm through a second suction stroke;
wherein the internal pressure chamber is configured such that the working fluid exerts the charge pressure on the first diaphragm and on the second diaphragm during both a first pressure stroke of the first diaphragm and a second pressure stroke of the second diaphragm.

2. The drive system of claim 1, wherein the first diaphragm, the second diaphragm, and the reciprocator are disposed coaxially on the first axis.

3. The drive system of claim 2, further comprising:
a first fluid cover abutting the first end of the first housing, wherein a circumferential edge of the first diaphragm is retained between the first fluid cover and the first housing.

4. The drive system of claim 2, wherein:
the first diaphragm includes a first attachment screw;
the reciprocating member is connected to the first attachment screw.

5. The drive system of claim 1, wherein the reciprocator is connected to the first diaphragm by a first intermediate member and connected to the second diaphragm by a second intermediate member.

6. The drive system of claim 1, further comprising:
an electric drive operably connected to the reciprocator to drive reciprocation of the reciprocator along the first axis.

7. The drive system of claim 6, wherein the electric drive includes an electric motor disposed outside of the first housing.

8. The drive system of claim 7, wherein the electric drive further comprises a gear reduction drive connected to the electric motor to receive a rotational output from the electric motor and connected to the reciprocator to drive reciprocation of the reciprocator.

9. The drive system of claim 8, wherein the gear reduction drive includes a crank shaft configured to rotate on a second axis and a cam follower offset from the second axis and configured to rotate about the second axis, and wherein the cam follower extends into a slot of the reciprocator.

10. The drive system of claim 1, wherein the internal pressure chamber is configured to be filled with the working fluid throughout both the first pressure stroke and the first suction stroke without the working fluid being exhausted from the internal pressure chamber.

11. The displacement pump of claim 10, wherein the first diaphragm includes a first flexible membrane, wherein a circumferential edge of the first flexible membrane is secured between a first cover connected to the first housing and the first housing, wherein the first diaphragm fluidly separates a first process fluid chamber defined by the first cover and the first diaphragm from the internal pressure chamber, and wherein the charge pressure is configured to bias the first flexible membrane into the first process fluid chamber during both the first pressure stroke and the first suction stroke.

12. A displacement pump comprising:
a housing at least partially defining an internal pressure chamber configured to be filled with a working fluid having a charge pressure;
a reciprocator disposed within the housing and configured to be driven along a first axis;
a first cover at least partially defining a first process fluid cavity;
a second cover at least partially defining a second process fluid cavity, wherein the housing is disposed axially between the first cover and the second cover;
a first diaphragm at least partially defining the first process fluid cavity on a first side of the first diaphragm and at least partially defining a first chamber on a second side of the first diaphragm, the first chamber fluidly separated from the first process fluid cavity by the first diaphragm; and
a second diaphragm at least partially defining the second process fluid cavity on a first side of the second diaphragm and at least partially defining a second chamber on a second side of the second diaphragm, the second chamber fluidly separated from the second process fluid cavity by the first diaphragm;
wherein the first diaphragm and the second diaphragm are connected to the reciprocator such that the reciprocator mechanically displaces the first diaphragm through a first suction stroke and mechanically displaces the second diaphragm through a second suction stroke; and
wherein the internal pressure chamber includes the first chamber and the second chamber, and wherein the internal pressure chamber is configured such that the working fluid concurrently exerts the charge pressure on the second side of the first diaphragm and on the second side of the second diaphragm.

13. The displacement pump of claim 12, wherein the internal pressure chamber further comprises a passage disposed within the first housing that extends between and fluidly connects the first chamber and the second chamber.

14. The displacement pump of claim 13, wherein the passage includes a plurality of passages.

15. The displacement pump of claim 12, wherein the first diaphragm includes a first flexible membrane, wherein a circumferential edge of the first flexible membrane is secured between the first cover and the first housing, and wherein the internal pressure chamber is configured such that the working fluid exerts the charge pressure on the first diaphragm during both a first pressure stroke of the first diaphragm and the first suction stroke to bias the first flexible membrane into the first process fluid chamber.

16. The displacement pump of claim 15, wherein the second diaphragm includes a second flexible membrane, wherein a circumferential edge of the second flexible membrane is secured between the second cover and the first housing, and wherein the internal pressure chamber is configured such that the working fluid exerts the charge pressure on the second diaphragm during both a second pressure stroke of the second diaphragm and the second suction stroke to bias the second flexible membrane into the second process fluid chamber

17. The displacement pump of claim 12, wherein the working fluid is in contact with the second side of the first diaphragm and the second side of the second diaphragm during the first suction stroke and during a first pressure stroke of the first diaphragm.

18. The displacement pump of claim 12, further comprising:
an inlet extending through the first housing and in fluid communication with the internal pressure chamber, wherein the internal pressure chamber is configured to be filled with the working fluid through the inlet.

19. The displacement pump of claim 12, wherein the internal pressure chamber is configured to be filled with the working fluid throughout both a first pressure stroke of the first diaphragm and the first suction stroke without the working fluid being exhausted from the internal pressure chamber.

20. The displacement pump of claim 12, further comprising:
an electric motor extending from the housing, the electric motor configured to generate a rotational output on a second axis transverse to the first axis;
a drive connected to the electric motor and the reciprocator, the drive configured to convert the rotational output from the electric motor to a linear reciprocating motion to cause reciprocator to reciprocate along the first axis.
